(19) United States
(12) Patent Application Publication
(10) Pub. No.: US 2004/0225588 A1
(43) Pub. Date: Nov. 11, 2004

(54) Method of operating a money market fund business

(76) Inventor: Walter G. Wojton, Pittsburgh, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/842,021

(22) Filed: May 7, 2004

Related U.S. Application Data
(60) Provisional application No. 60/468,611, filed on May 7, 2003.

(51) Int. Cl. G06F 17/60

(52) U.S. Cl. 705/35; 705/36

(57) ABSTRACT

A method for producing a return from investment funds includes receiving a principal; identifying first and second investment funds; contracting with a client to establish payment of first and second fees associated with the first and second investment fund, respectively; distributing the principal among the first and second investment fund; obtaining first and second yields for the first and second investment fund, respectively, wherein the first yield is larger than the second yield; identifying an anchor and lagging fund; conveying the first yield to the client; receiving the first fee from the anchor fund; determining a yield enhancement by subtracting the second yield from the first yield; determining an enhanced yield by adding the yield enhancement to the second yield; conveying the enhanced yield to the client; determining the second fee by subtracting the yield enhancement from the first fee; and receiving the second fee from the lagging fund.

### BACKGROUND OF THE INVENTION

1. Field of the Invention

This invention relates to investment funds such as money market funds and, more particularly, to a method for producing a higher total return for clients who place principal in the investment funds.

2. Description of Related Art

Various fund companies wish to have their investment funds, such as money market funds (“MMF”), receive more exposure in the marketplace. In the case of MMF, one way of accomplishing this goal has been for the investment company to employ a broker dealer (“B/D”) to act as a portal between the clients and the MMF. This is particularly true with respect to institutional MMF. Particularly, the B/D contracts with various institutional MMF in order to distribute the MMF products to the institutional marketplace. There are several brand names as well as small independent portals out there, such as treasurypoint.com operated by SEI Investments and MoneyFunds Direct operated by the Bank of New York.

The benefits of using a portal for the institutional investor are diversification and convenience. The MMF agree to pay all portals a monthly fee (distribution or administrative fee) of anywhere from five to ten basis points based on average daily assets funneled through the portal. It is to be understood that each basis point equals 1/100^{th} of a percent. The end user or client (for example, a Fortune 500 company) gains the convenience of dealing with one source for their money fund investments as well as consolidated information on the available funds and their balances. The client also gains the investment diversification desired or mandated by the client's corporate investment policies (they can typically use a choice of only five or so funds).

The MMF benefit from cost savings on their sales since the portal fees are all variable costs. The portals benefit because they can leverage their contacts and clients into creating fee income “out of thin air”.

There remains a need, however, for the client to realize a higher yield than they are now receiving, while still enjoying the diversification and convenience they desire.

### SUMMARY OF THE INVENTION

To overcome the deficiencies of the prior art, what is needed, and has not heretofore been developed, is a method of producing a higher total return for clients who place principal in the investment funds. Therefore, it is an object of the present invention to offer investors, for example, institutional investors, the ability to simultaneously access more than one investment fund (for example, money market funds) to manage their assets (for example, cash). It is a further object to provide a method whereby the client realizes a higher total return than could be procured if the client contacted each investment fund individually or simply used the existing state-of-the-art portal methodology. It is still further an object of the invention to provide the client with the current primary benefits using a portal and to add the substantial benefit of reaping a yield on all of the approved funds in their approved funds list which is equal to the yield of the highest performing fund thereon.

The present invention provides a method for producing a return for clients who place principal in investment funds, wherein the method comprises the steps of contracting with a client; receiving a principal from the client; identifying an investment category for investing the principal, wherein the investment category is comprised of first investment fund and a second investment fund; contracting with the client to establish payment of a first fee associated with the first investment fund and a second fee associated with the second investment fund; distributing the principal among the first investment fund and the second investment fund; obtaining a first yield and a second yield for the first investment fund and the second investment fund, respectively, wherein the first yield is larger than the second yield; identifying an anchor fund and a lagging fund for the investment category, wherein the anchor fund corresponds to the first investment fund and the lagging fund corresponds to the second investment fund; conveying the first yield to the client; receiving the first fee from the anchor fund; determining a yield enhancement by subtracting the second yield from the first yield; determining an enhanced yield by adding the yield enhancement to the second yield; conveying the enhanced yield to the client; determining the second fee by subtracting the yield enhancement from the first fee; and receiving the second fee from the lagging fund. The yield enhancement may be adjusted so that the yield enhancement is not greater than the first fee. Additionally, the second fee is not distributed to the portal if the difference between the first yield and the second yield is equal to the first fee.

Still other desirable features of the invention will become apparent to those of ordinary skill in the art upon reading and understanding the following detailed description.

### BRIEF DESCRIPTION OF THE DRAWINGS

FIG. 1 is a diagram illustrating the fundamental flow of money between a client, a B/D, and an MMF according to a preferred embodiment of the invention;

FIG. 2 is a chart illustrating the improvement in yield realized by implementation of the present invention; and

FIG. 3 is a flow chart setting forth the basic steps according to a preferred embodiment of the invention.

### DESCRIPTION OF THE PREFERRED EMBODIMENTS

In a presently preferred embodiment of the invention, the prior practice of a B/D acting as a portal between an MMF and institutional investors is redesigned so that the client gets a higher yield than they are now receiving and the diversification and convenience that the client desires. In sum, this could be accomplished by establishing a new B/D to act as a portal for institutional MMF. It is to be understood that the portal may also be a fund company, bank, or the like. The B/D would contract with a large existing institutional MMF or a large retail fund that has slightly outperformed (for example, by three to six basis points) the bulk of the market share leading institutional MMF. The fee to be paid to the B/D from the MMF, under these circumstances, would be usually from three to five basis points. The B/D would then contract with the lower yielding funds in the same category on a similar basis. The B/D would then derive its income from only the higher yielding fund (“the Anchor Fund”), and the B/D would then pass along the fees received from the lagging funds in order to give the client a subsidized return or “enhanced yield”.

Referring to FIG. 1, a diagram illustrating how the enhanced yield is provided to the client is shown. Particularly, the client provides principal to the B/D 12. The B/D 12 then places that principal among several MMF, including an Anchor Fund and several lagging funds. For brevity, only one MMF 14 (a lagging fund) is shown in FIG. 1. The MMF 14 then credits a yield back to the B/D 12, based on the principal, in the well-known manner. According to a distribution contract or administrative services agreement previously entered by the B/D 12 and the MMF 14, the MMF 14 credits a fee (for example, five basis points) to the B/D 12.

Instead of retaining the entire fee on its own account, the B/D 12 adds at least a portion of the fee (for example, three basis points) to the yield that the B/D 12 had received from the MMF 14 based on the principal. The B/D 12 then conveys an enhanced yield (“yield⁺”) to the client 10. Preferably, this yield⁺ will be equal to the standard yield produced by the higher performing Anchor Fund, in which the client 10 has placed another portion of its principal through the B/D 12.

In the case of the Anchor Fund, the fee received from the Anchor Fund would not be passed on from the B/D 12 to the client 10, so that the B/D 12 may realize revenue on its own account. It should be noted that a client's Anchor Fund may be periodically changed by the B/D, to take advantage of aberrations in outperformance of a given fund on a given day.

Again, only one MMF 14 and one client 10 is shown in FIG. 1 for clarity. However, it will be understood that when operating the current system and method of the present invention, there will be numerous clients passing principal to the B/D 12. The B/D 12 would, in turn, be placing that principal with not just one MMF 14, but rather an Anchor Fund and several (for example, 10-20) MMF 14, which other funds might be called “lagging funds”.

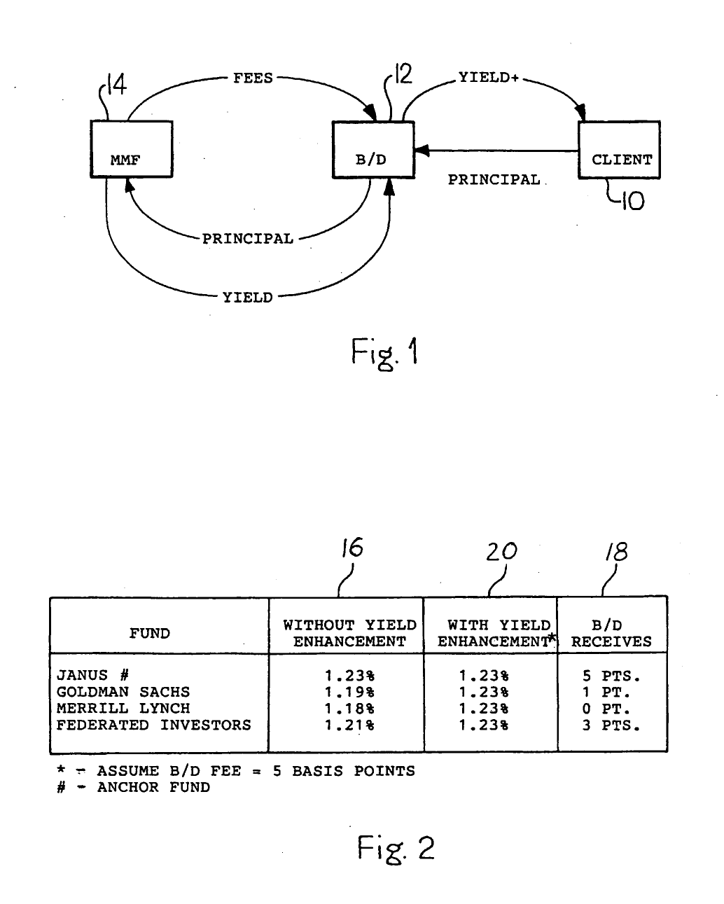

Referring to FIG. 2, a chart may be used to further illustrate the present invention. In the example of FIG. 2, there are only four MMF 14. The Anchor Fund, Janus®, outperforms the remaining MMF 14 by two to four basis points. This is detailed in the second column 16 in FIG. 2. This example also assumes that each fund pays the B/D 12 a distribution or administrative fee equal to five basis points. Therefore, when the system and method according to the present invention is in place, Janus®, the Anchor Fund, produces a yield of 1.23% to the client. This is then the benchmark yield for this particular grouping of MMF. The yield produced by the Anchor Fund, Janus®, is passed through the B/D 12 to the client 10, with no enhancement. Thus, the B/D 12 retains five basis points as a distribution fee, as set forth in the last column 18 of FIG. 2.

Moving down one line in FIG. 2, the Goldman Sachs® Fund produces a yield of 1.19% and is under contract to the B/D 12 to pay a distribution fee of five basis points. Thus, in order to boost the yield of the Goldman Sachs® Fund so that it matches the benchmark Anchor Fund, Janus®, the B/D 12 contributes four of its five basis points and passes this directly along to the client 10. Thus, the Goldman Sachs® Fund produces, by means of the invention, an enhanced yield of 1.23% to the client 10. This is listed in the third column 20 of FIG. 2. As indicated in the last column 18 in FIG. 2, the B/D 12 retains one basis point as its distribution fee respecting the Goldman Sachs® Fund.

Moving down yet another line in FIG. 2, the Merrill Lynch® Fund produces a yield of 1.18%. Therefore, in order to boost the yield of this fund to equal Janus®, the B/D 12 contributes all five of its basis points and passes these along to the client 10 so that the client realizes a 1.23% yield from the Merrill Lynch® Fund, as set forth in column 20. In this case, the B/D 12 retains no portion of its distribution fee, as set forth in column 18. Similar logic applies to treatment of the Federated® Fund, according to the invention, as set forth in the bottom line of the chart in FIG. 2. It is preferred that the B/D 12 not go into its own pocket to raise the yield on a given lagging fund to equal that of the benchmark fund. Thus, in the last example, if Merrill Lynch was only yielding 1.17%, then the B/D 12 would contribute 5 basis points to raise the yield to 1.22%, one point short of the benchmark 1.23% yield of Janus.

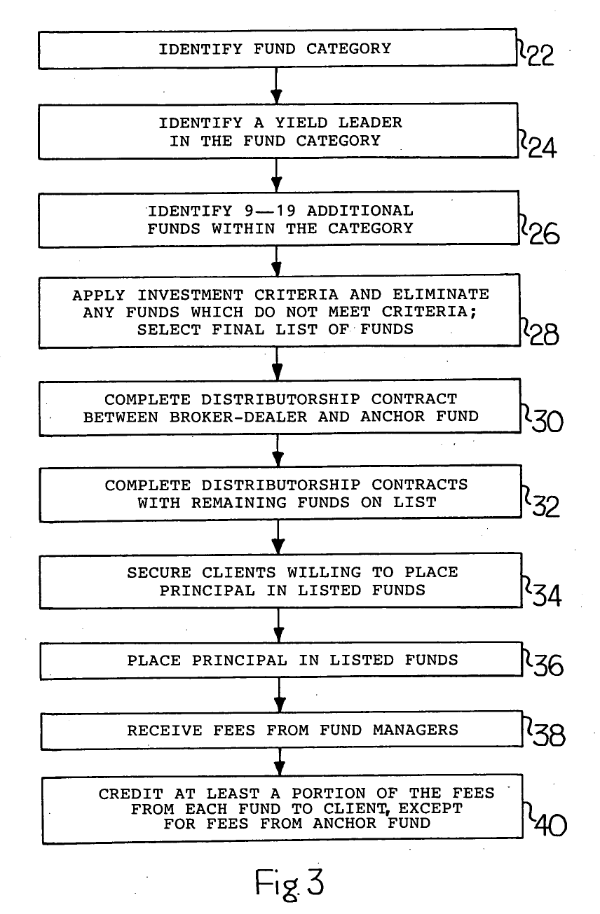

Referring to FIG. 3, a flow chart for illustrating the major steps in creating and implementing a system according to the present invention is shown. First, after the B/D is set-up, it must identify a category, as shown in block 22. For example, the category might be all AAA rated MMF, MMF over $5B in size, tax free MMF, treasury funds, government funds, commercial paper, etc.

Block 24 shows the next step, i.e., identifying a yield leader in the fund category. The yield leader, or Anchor Fund, must be willing to give the B/D a contract to place customers (and to rollover existing customers) into the Anchor Fund. The Anchor Fund must typically have a strong name, such as Smith Barney® or Prudential® or Janus®, they must have a high level of credibility in the market, and they must already have billions of dollars placed in their funds. Importantly, the ideal Anchor Fund will produce a yield of roughly two to five basis points higher than the other funds in its category for one or more reasons including, but not limited to, excellent fund management, large asset base or fund, low levels of volatile trading inside the fund, etc.

As set forth in block 26, an additional 9 to 19 funds in the same category must then be identified. Then, as set forth in block 28, the B/D criteria must be applied to the additional identified funds to make a final list of funds to be coupled with the previously identified Anchor Fund. Generally, the additional funds will be of the same general size as the Anchor Fund, will be classified in the same category as the Anchor Fund, and will have been in business approximately the same length of time as the Anchor Fund. Importantly, all of the funds in the final list must agree with the B/D to remain under contract with the B/D for a minimum amount of time to avoid confusion among the clients. It is anticipated that the managers of the additional funds will pay a premium to the B/D, in exchange for getting the added visibility with the clients, which is provided by the system and method of the present invention.

As an aside, the system and method of the present invention is particularly applicable to MMF because they are near commodities at this point in time. Since they are near commodities, the main decision point in investing in MMF is the yield. However, it is also envisioned that the system and method according to the present invention could be applied to mutual funds or bond funds, as will be apparent to those skilled in the art upon reading the instant specification.

Referring to block 30 in FIG. 3, once the Anchor Fund and the additional funds have been identified, and the investment criteria applied, the B/D must complete distribution or administrative services agreements between the B/D and the Anchor Fund and also between the B/D and the remaining funds, as set forth in block 32. As mentioned above, a key point in these contracts will be an agreement by the funds to remain under contract to the B/D for a minimum period of time, (for example, three years), to avoid confusion. It would also be helpful for the B/D to extract a promise from each fund that the fund will not enter into similar distribution or administrative services contracts with other entities.

As shown in block 34, once the B/D has all of the funds under one contract, the B/D must then go to the market and secure clients that are willing to place principal in the listed funds. This could be done via the Internet, as well known in the art. It is also anticipated that the treasurers or CFO's of public companies, such as Fortune 500 companies, would be a target market for applying the system and method of the present invention. These persons and corporations would represent the clients 10, as set forth in FIG. 1. These sorts of clients often have large cash accounts (for example, $300 to $500 million) which they must manage, yet their corporate investment policies require diversification. This diversification requirement mandates that, whenever cash is placed in an MMF, more than one fund (for example, five funds) must be utilized. The present invention provides that the client 10 may have a single, convenient source for managing its cash investments yet obtaining the diversification it requires. Importantly, although diversified, the present invention provides that the yield from all of the various funds in which the cash is invested may be equal (or close to equal) to that of the higher performing Anchor Fund.

As set forth in block 36, once the B/D 12 has secured the client 10, the principal from the client must be placed in the MMF 14. Preferably, the B/D 12 and client 10 have previously entered an agreement whereby the client 10 agrees to invest a minimum amount of its cash in the Anchor Fund and, more preferably, to keep a minimum balance in the Anchor Fund. This ensures the B/D 12 of a minimum cash flow income from the distribution fees provided by the Anchor Fund.

As set forth in block 38 and illustrated in FIG. 1, the B/D 12 receives a distribution fee from the MMF 14. Then, as set forth in block 40, at least a portion of these distribution fees from each fund are credited to the client 10 by the B/D 12, except of course the distribution fees originating from the Anchor Fund.

As a more specific example of how the money flows according to the system and method of the present invention, the B/D 12 obtains principal of the client 10 and places that principal with the MMF 14, as described above. On a daily basis, the B/D 12 would know how much money each client 10 had in each MMF 14. The MMF has an annual yield (for example, 1.23%) and each day the MMF 14 declares a dividend factor. The dividend factor equals the yield divided by 365 days (for example, 1.23%÷365). The yield factor is applied by the B/D 12 each day to the account balance of the client 10 in the particular fund, and the resulting amount is credited to the client's account. This is the unenhanced yield.

As previously mentioned, the MMF 14 is obliged to pay a distribution or administrative fee to the B/D 12. This is conventionally expressed in a number of basis points (for example, five). These basis points are figured on an annual yield basis. For example, the annual distribution fee on $100M in principal would be $50,000. Thus, at the end of each day, one can calculate the distribution fee owed by the MMF 14 to the B/D 12 based on a given client's account balance for that day. The B/D 12 makes this calculation and, except in the case of the Anchor Fund, credits this daily portion of the distribution fee to the account of the client 10. This extra amount credited to the client 10 results in the enhanced yield provided by the present invention and set forth as an example in column 20 of the chart in FIG. 2. It is anticipated that the B/D 12 would have a custom software package to keep track of the enhanced yield accounting.

Practically speaking, the MMF 14 would typically wire the distribution fees to the B/D 12 on a periodic basis. The B/D 12 would then credit this amount to the client 10 to produce the enhanced yield. It may be necessary for the B/D 12 to use a line of credit to pay the accrued enhanced yield to the client before the distribution fees are actually wired by the MMF 14. Alternatively, the B/D 12 may have a policy whereby the distribution or administrative fees are passed on to the client 10 only at the time the client's account with the B/D 12 is closed.

Preferably, the contracts between the MMF and the B/D will have a term of at least one-year. It is also preferred that these contracts might be automatically renewable upon the B/D achieving certain performance targets (for example, keeping an aggregate minimum average daily balance in the MMF over the course of the year).

It will be appreciated by those skilled in the art that the method and system of the present invention provides a winning situation for the MMF, the B/D, and the clients.

While the presently preferred embodiments of the invention have been described herein, it is in no way intended to limit the invention to the particulars set forth herein. Various modifications, adaptations, and alternative embodiments of the invention (such as applying the invention to mutual funds or bond funds) will be apparent to those skilled in the art upon reading the instant specification without departing from the spirit and scope of the present invention. It is intended that the invention be construed as including all such modifications, combinations, and alterations insofar as they come within the scope of the appended claims or the equivalents thereof.

The invention claimed is:

1. A method for producing a return for clients who place principal in investment funds, the method comprising the steps of:
contracting with a client;
receiving a principal from the client;
identifying an investment category for investing the principal, wherein the investment category is comprised of a first investment fund and a second investment fund;
contracting with the client to establish payment of a first fee associated with the first investment fund and a second fee associated with the second investment fund;
distributing the principal among the first investment fund and the second investment fund;
obtaining a first yield and a second yield for the first investment fund and the second investment fund, respectively, wherein the first yield is larger than the second yield;
identifying an anchor fund and a lagging fund for the investment category, wherein the anchor fund corresponds to the first investment fund and the lagging fund corresponds to the second investment fund;
conveying the first yield to the client;
receiving the first fee from the anchor fund;
determining a yield enhancement by subtracting the second yield from the first yield;
determining an enhanced yield by adding the yield enhancement to the second yield;
conveying the enhanced yield to the client;
determining the second fee by subtracting the yield enhancement from the first fee; and
receiving the second fee from the lagging fund.

2. The method of claim 1, further comprising the step of adjusting the yield enhancement so that the yield enhancement is not greater than the first fee.

3. The method of claim 2, wherein the second fee is not distributed to the portal if the difference between the first yield and the second yield is equal to the first fee.

4. The method of claim 1, further comprising the steps of:
applying the first yield to the principal; and
applying the enhanced yield to the principal.

5. The method of claim 1, wherein the first fee and the second fee are expressed in basis points.

6. The method of claim 5, wherein each basis point equals 1/100^{th} of a percent of one of the first yield, the second yield, and the enhanced yield.

7. The method of claim 5, wherein the first yield is two to five basis points higher than the second yield.

8. The method of claim 1, wherein the first fee is one of a distribution fee and administrative fee associated with average daily principals distributed through the portal.

9. The method of claim 1, wherein the client is one of an institutional investor and an investment company.

10. The method of claim 1, wherein the portal is one of a broker dealer, a fund company, and a bank.

11. The method of claim 1, wherein one of the first yield and the second yield are expressed as annual yields.

12. The method of claim 11, wherein the first investment fund declares:
a first dividend factor, wherein the first dividend factor is equivalent to the first yield divided by 365 days; and
a second dividend factor, wherein the second dividend factor is equivalent to the second yield divided by 365 days.

13. The method of claim 12, wherein the first fee and the second fee are determined on a daily basis.

14. The method of claim 1, wherein the investment category is comprised of a plurality of money market funds.

15. The method of claim 1, wherein the investment category is selected from one of the following: money market funds; treasury government funds; and commercial papers.
